(19) United States
(12) Patent Application Publication
(10) Pub. No.: US 2008/0040753 A1
(43) Pub. Date: Feb. 14, 2008

(54) Video display device and method for video display from multiple angles each relevant to the real time position of a user

(76) Inventors: Atul Mansukhlal Anandpura, San Diego, CA (US); Sunil Hitendrasinh Solanki, San Diego, CA (US); Nagvendra Singh, San Diego, CA (US)

Correspondence Address: DONN K. HARMS;PATENT & TRADEMARK LAW CENTER, SUITE 100, 12702 VIA CORTINA, DEL MAR, CA, 92014, US

(21) Appl. No.: 11/891,198

(22) Filed: Aug. 8, 2007

Related U.S. Application Data
(60) Provisional application No. 60/837,270, filed on Aug. 10, 2006.

(51) Int. Cl. G06F 3/00; H04N 7/173

(52) U.S. Cl. 725/60; 725/131; 725/37

(57) ABSTRACT

A portable video display for use at venues such as sports stadiums having a spectator seating surrounding a field of play. Using video feeds from a plurality of cameras surrounding the field of play at a plurality of different viewing angles the device will ascertain the user's relative position to the field of play. A keyboard allows the user to designate a desired camera viewing angle to be displayed and onboard software correlates the desired viewing angle to the correct one of the viewing angles provided by the surrounding cameras based on the relative position of the user to the field of play.

This application claims the benefit of U.S. Provisional Patent Application No. 60/837,270, filed Aug. 10, 2006. This invention relates generally to portable video displays, audio visual players and the like. More particularly, it relates to a portable video display device adapted to receive and display video and audio in real time, relevant to the game, concert, or other event being held at a venue such as a stadium, theater, or racetrack. Employing a control pad adapted for user selection of viewing angles, the device displays the video in a manner which is oriented to the individual seat or position of any user in the venue.

### FIELD OF INVENTION

### Background

Sporting events such as soccer or football are attended by thousands of fans for each game. Modern stadiums frequently have large screens on which video of the event is played for viewing by the fans from a distance. Miniature televisions and even cellular phones also offer video of the game or other events being held. However, all such displays feature video of a general nature which may or may not be displayed on the screen from an angle relevant to individual users and their position inside the stadium, racetrack, theater, or other venue.

An example of such a video display would be the Sony Jumbotron which is a very large and bright screen that occupies a position at a stadium and is used for instant replay of some play or occurrence at the venue relevant to the game or event being held there. However, fans sitting on one side of the field or perhaps at a goal end of the field will generally be viewing such video playback at the wrong angle depending on the seat they are occupying in the stadium. This is because television cameras used to record the event are situated at various points about the stadium and the video displayed on the screen for fans can only be provided from the viewing angle of the camera.

Further, at many venues such as a race track or motocross track, there may be many positions about the track where a plurality of different participants in the event are concurrently performing their sporting or athletic feats. However, fans and attendees are also situated at a plurality of positions at the venue. Consequently, they miss many occurrences at the event which happen at the other positions they cannot see from their seat.

Accordingly, there is an unmet need for a device and method which will provide users with video displays of individual occurrences during an event at a specific venue that may be displayed in a fashion to the individual user which yields the correct viewing angle for their individual position at the venue. Such a device should either determine itself, its relevant position at the venue, or allow the user to input their position or seat at the venue and thereafter provide user input means to display video from user-chosen angles that are displayed at those angles relevant to the user position.

Further, such a device should provide for easy intuitive user-input of the viewing angle the user wishes on any given segment of video which can be displayed. Such a device should also only operate proximate to the venue at which it is being employed by users so that its use will not impact attendance at the event.

### SUMMARY OF THE INVENTION

There is disclosed and described herein a portable video display device which employs an onboard screen display viewable by the user. Also provided are a keypad or a touch screen having displayed keys, either of which would provide an intuitive set of input keys for user input of desired viewing angles for video provided of occurrences at the event they are attending.

The device provides means for determining the location, and thus the viewing angle, of each user of a respective device at a venue such as a stadium or racetrack. One means for location determination is provided by automatic determination wherein an onboard component employs GPS or triangulation of terrestrial electronic signals to determine its exact location and ascertains the position of the user at the venue in question. Or, the device may allow the user to input their seat number or stadium location into the device, whereafter it will determine the relevant position of the user at the venue.

When employed for specific venues, the device will hold relevant mapping of the venue locations in onboard memory and use software adapted to the purpose to ascertain the relative location of the user. One or a plurality of different venues might be stored on a device and allow it to be used at multiple venues. Or, the device may query a communications node at an individual venue, and thereafter communicate through a wireless, infrared, or other means of communication with a computer or network at the venue upon arrival, wherein an electronic map or other electronic rendition of the venue would be imparted to the device and allow the device to function at that venue. Thereafter the user's position would be ascertained, relevant to the sporting or other event being held there.

Upon the device ascertaining the user's position relevant to the event being held at the venue, the user may employ a unique keypad offering a plurality of viewing angles relevant to their location for video such as instant replay to be displayed on the device. The video would be transmitted to the device from the communications node at the venue. Depending on the viewing angle key chosen by the user, video is displayed from one of a plurality of available viewing angles relevant to the user's position at the venue.

Using GPS, or a triangulation of terrestrial broadcast signals, the device can determine its exact location at the venue and employ onboard to relate the user depressible keys on the device to the user's position. Or, the user may be provided a video display of the stadium initially or some other means to determine their position therein and be queried to input their location. The same onboard software would thereafter relate each of the plurality of viewing angle keys to the user's position. Thereafter, the user of the device has the option of depressing any of the plurality of keys in an oval or circular pattern starting and returning to a home key and receiving video from that viewing angle.

The video for the various angles would be provided by cameras located in the venue in a circular pattern surrounding the event on the stage, track, or field of play. Each of the cameras would provide real time or recorded video from its respective angle which when broadcast to each individual device of each user at the venue would be displayed by user-depressed keys in a fashion where the camera view displayed is relevant to the user's position in the venue.

The device would provide the user with a home key which from the user's perspective would be a frontal or direct view of the game or other event on the field of play. The other keys on the keypad when depressed display live or recorded video from the camera with the angle relating to the individual key relevant to the user's position. Thus, for example, a user can see the display of the event from a normal viewing angle pushing the home key or the reverse field angle from the other side of the field by pushing the key opposite to the home key. Audio relevant to the video being displayed would also be provided. All of the video and audio would be transmitted to the device from the communications node. The devices may be rented or given to users at the venue itself or in advance of the user's arrival at the venue and allow the user to bring it to the event.

As shown, the display is provided by an LCD and onboard power would be provided by a battery. A Memory Card Slot can be provided to allow card-oriented data to be input. Sound would be provided by onboard speakers, or headphones can be engaged in a headphone jack. Connectors for USB or Cat 5 or other means for wired engagement can also be provided so the device can be programmed via a computer or on a network. Wireless communication would employ an antenna and onboard receiver or an infrared receiver. Software onboard for the noted functions would run on a computing device or microprocessor adapted to the task and having appropriate audio and video inputs and outputs.

In this respect, before explaining at least one embodiment of the device herein in detail, it is to be understood that the invention is not limited in its application to the details of construction, and to the arrangement of the components or method steps set forth in the following description or illustrated in the drawings. The invention is thus capable of other embodiments and of being practiced and carried out in various ways and in different order of execution. Also, it is to be understood that the phraseology and terminology employed herein are for the purpose of description and should not be regarded as limiting.

As such, those skilled in the art will appreciate that the conception upon which the system and method is based may readily be utilized as a basis for designing of other methods and software driven systems for carrying out the several purposes of the present invention. It is important, therefore, that the claims be regarded as including such equivalent construction insofar as they do not depart from the spirit and scope of the present invention.

It is an object of this invention to provide a video display device providing video to a user at an event at viewing angles relevant to their position at the venue.

It is a further object of this invention to provide such a device that also provides a user keypad which is intuitive and easy to use to allow the user to choose the viewing angle desired for displayed video.

An additional object of this invention is to provide such a device that allows for easy orientation of the device to its position at a venue using electronic triangulation or manual input by a user.

These together with other objects and advantages which will become subsequently apparent reside in the details of the construction and method as more fully hereinafter described and claimed, reference being had to the accompanying drawings forming a part thereof, wherein like numerals refer to like parts throughout.

### BRIEF DESCRIPTION OF DRAWING

FIG. 1 depicts a top view of the display device showing the display screen and keypad for user input.

FIG. 2 depicts a typical stadium having a plurality of camera viewing angles from which video may be communicated to the device relative to the position of the user.

FIG. 3 is a perspective view of the device showing other components for operation thereof.

FIG. 4 depicts a flow chart showing a typical method of operation at a stadium having a playing field.

### DETAILED DESCRIPTION OF PREFERRED EMBODIMENTS

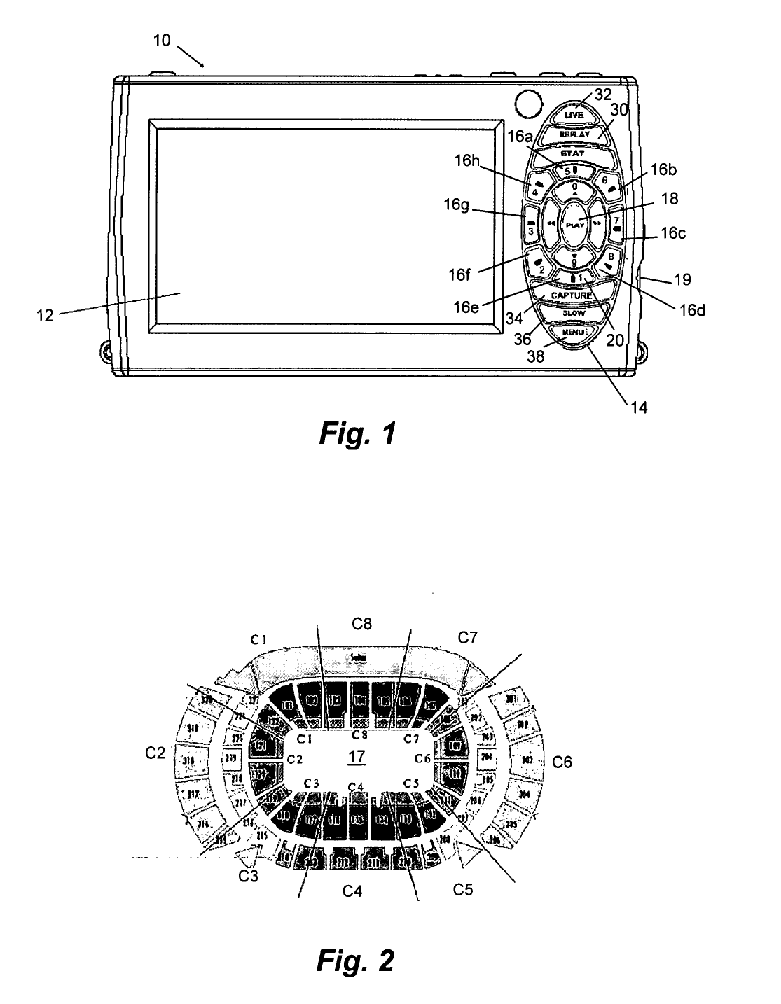

As noted, FIG. 1 depicts an exemplar display device 10 having a display screen 12 and keypad 14 which is intuitively adapted for easy user input of the user-desired viewing angle to be displayed on the screen 12. A plurality of camera keys 16a-16h are arranged in a generally circular orientation around a center key 18 with the camera key 16e serving as a home key 20 at the bottom of the camera keys 16a-16h closest to the user.

The device 10 employs an onboard a means for determining its relevant location in the seating around a spectator venue such as a stadium 22. As noted above, this means for determining relevant location at the venue relevant to the position occupied by the user is provided either by GPS, or triangulation of terrestrial electronic signals, or by allowing the user to input their seat number or stadium location into the device 10 which would have the positions of seat locations relative to the plurality of cameras in memory or retrievable from a server. Once the position of the user in the venue has been ascertained, onboard software adapted to the task will determine the relevant position of the user of the device 10 in relation to the plurality of cameras providing real time video of the event and field of play at the venue, from a plurality of camera angles relative to the user.

Once this relative location in the venue is determined, thereafter pressing the home key 20 will provide the user a straight-on view of the field of play in front of the user at the venue. The user may display video feeds on the screen 12 from the plurality of field viewing angles relevant to the user's location in the venue by pushing any of the camera keys 16a-16h to render a view on the screen 12 from the angle of the camera key 16a-16h chosen. Should any confusion by the user arise, they can always push the home key 20 for a straight-on view of the event in front of them.

The video feed for each of the various angles is communicated from video cameras located in the venue in a circular pattern surrounding the event on the stage, track, or field of play which relate to the positions of the camera keys 16a-16h. Each of the cameras therefor captures video of the event from different angles C1-C8 around the field of play 17. Video from each of these angles when displayed on the screen 12 for each individual user, at each relative position in the venue, will be displayed on their respective device 10 with the viewing angles C1-C8 initiated by pressing the camera keys 16a-16h, displayed on the screen 12 relative to the user's location in the venue.

For instance, a user viewing from section C4 of FIG. 2 pressing the camera key 16e which is also the home key 20 would get a view from camera C4 toward the center of the field 17. Pressing the camera key 16c on the user's right yields a view from C6. However, since the device 10 self-orients in the venue, a different user sitting in section C8 pressing the camera key 16e which is the home key 20 will see a view from C8, and pressing the camera key 16c on the right of the keypad would yield a view of the field 17 from the camera at C2.

Communication to the device 10 of video and audio for display at the relevant angles is provided by wireless means of communication such as WiFi, infrared, radio, or other means for data transmission to and/or from the device 10. The data regarding the venue itself and terrestrial relevant locations in the venue may be stored on the device 10 in onboard memory, or insertable memory card 19, or communicated to the device 10 when it becomes proximate to the venue by wireless means such as cellular communication. If provided on a memory card 19, the card 19 can also act as authorization for the user to have and use the device 10. Such cards 19 could be mailed to the user in advance of the game or handed out on entering the venue to allow users to authenticate their devices 10 for use and input venue data if necessary. This mode of operation would allow the user to buy or have possession of the device 10, and use it in an infinite number of venues by simply inserting the memory card 19 authorizing use at the venue being visited and updating onboard software as to the specifics of the venue and cameras available.

Alternatively the venue data may be communicated into the device 10 prior to arriving proximate to the venue using a computer network communicating through a wired or wireless communication. As noted, one device 10 may be configured with software and resulting video display capabilities specific to an individual venue, or might have software making it adaptable to a plurality of different venues depending on data transmitted to it or delivered on a memory card 19. Each venue displayed by the device 10 will of course always ascertain the relative user position in that venue using GPS, radio triangulation, or other means for location determination. Once so determined, when any of camera keys 16a-16h are pushed, the appropriate relative camera angles C1-C8 to the user's individual position facing the field 17 will be displayed.

The device 10 employing onboard memory and processing software can provide the user with a number of functions that are not normally available to spectators. First, with sufficient memory onboard and for storage capacity, the device will store live video feed from at least one and preferably all of the cameras C1-C8. Subsequently, the user may press the replay key 30 in association with any one camera key 16a-16h, and a replay of the field 17 from the designated camera key will be displayed on the screen. The user can actually view a sports play or other field related item from any of the camera views available. Depressing the live key 32 will bring the display 12 back to depicting live action from the field 17.

Should a play from any of the cameras C1-C8, be particularly desirable to keep, pressing the capture key 34 will store the video to memory for later use. Should the user decide that the live feed or the replay would be more revealing in slow motion, pressing the slow key 36 will provide that function to any camera view chosen. A memory buffer for video streams from the cameras will maintain the device's ability to display current and other instant replays if a user is viewing something else at the time.

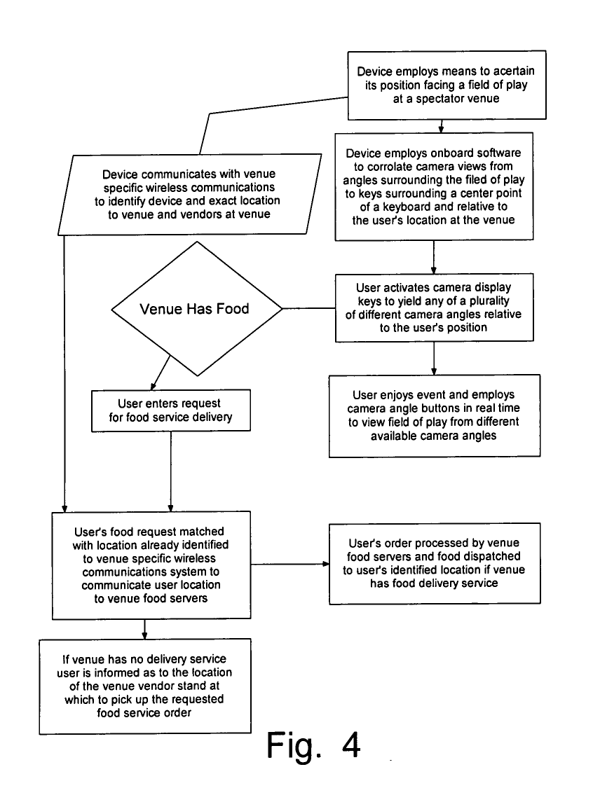

Finally, depressing the menu key 38 can either display the operational menu for the device 10, or with proper software and onboard communications the device 10 may also provide the user with an electronic means for ordering products such as food and souvenirs while at the venue as shown in FIG. 4.

For example the device 10 may be employed to order food such as the old American favorite, hot dogs and beer, while seated at a baseball game. Since the device 10 ascertains the position of the user in the stadium or venue, the food ordered could be subsequently delivered.

Alternatively, the device would determine the closest refreshment stand to the user and direct the user to it for pick up. The user may input a credit card or other payment method which would be transmitted by the device 10, for electronic payment for the food in advance of its delivery to the user's seat, or the user visiting the refreshment stand. Using the device 10 for ordering and payment and delivery, the user would download the menu from the venue refreshment stands via the wireless communication. Next, the user would employ the menu on the screen 12 and designate an order using the keys, or a touch screen interface to allow the user to simply touch the screen 12 to order using a graphic interface. Once the order is completed, the device 10 would transmit the seat location, food order, and payment information to the venue refreshment stand. Finally, the food would be delivered to the user's seat which was identified in the order.

Alternatively, the devices 10 may be employed to simply transmit a desire for food of a type sold by walking sellers at sports venues such as ice cream or peanuts. The venue management would employ this transmitted information as a guide means or a real time map of areas of the venue where one or more users are signaling they are hungry or thirsty for certain foods, whereafter appropriate walking vendors could be directed to those locations in the stadium. Thus the users get quicker walking vendor services and the walking vendors get more sales by visiting areas of the stadium identified by the devices 10 as in need of specific items.

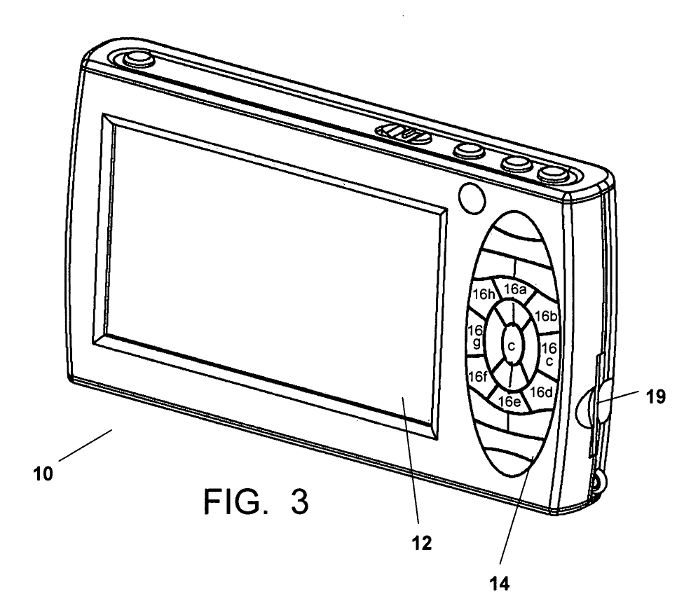

As depicted in FIG. 3, labeling and functions of the keys of the keypad 14 need not be in the exact depicted manner herein shown in the figures. As those skilled in the art will no doubt realize, as long as the camera keys 16a-16h are positioned around a center point “C” on the keypad 14, and yield the view of the appropriate camera C1-C8 once the device has self-oriented in the stadium, the device will function easily and intuitively for the user. The other keys of keypad 14 may be labeled for many functions noted herein in different positions.

Thus, the user pressing camera key 16e will always get the camera view from the venue of the camera behind the user. Conversely, the user in the same position in the venue pressing camera key 16a, will always get a view from the angle on the opposite side of the field of play which gives the user the ability to see the other side of the players from his own relative position. Since the device self-determines its relative position in the venue around the playing field, software onboard will automatically adjust which camera is activated by which camera key always relative to the user's position.

Further, the keyboard 14 need not be mechanical but can be a virtual keyboard 14 depicted on the screen 12 with touchscreen capability. As a virtual keyboard 14, the device and method herein are not limited to the device 10 itself since the virtual keyboard 14 would take up some of the displayed picture area. It is conceivable the screen 12 might be made bigger to accommodate a virtual keyboard 14, or a separate screen 12 adjacent to the main screen 12 could be provided specifically to depict a virtual touchscreen keyboard thereon. This would allow reshaping or configuration of the keyboard itself to accommodate changes in functions, or to be venue specific keyboards. Of course in any mode of the keyboard 14, the device 10 works best if a plurality of keys designating camera views are positioned in a generally circular or oval pattern around a center point and each such key in the plurality relates to the activation of a camera yielding that relative view to the user.

The self-orienting video display device and method shown in the drawings and described in detail herein features arrangements of elements of particular construction and configurations for preferred embodiments of the present invention. It is to be understood, however, that elements of different construction and configuration and other arrangements thereof, other than those illustrated and described, may be employed for providing a device within the spirit of this invention.

As such, while the present system and method of the invention has been described herein with reference to particular embodiments thereof, a latitude of modifications, various changes and substitutions are intended in the foregoing disclosure, and it will be appreciated that in some instance some features of the invention could be employed without a corresponding use of other features without departing from the scope of the invention as set forth in the following claims. All such changes, alternations and modifications as would occur to those skilled in the art are considered to be within the scope of this invention as broadly defined in the appended claims.

What is claimed is:

1. A portable video display apparatus for employment at a venue having a spectator viewing section surrounding a field of play and a plurality of cameras communicating individual video transmissions of said field of play from a plurality of different viewing angles of said field of play, comprising:
a housing having a video display on a first surface;
means to communicate said individual video transmissions of said field of play to said video display apparatus;
means to process said individual video transmissions for display by said video display;
means to ascertain a relative location of said video display in said spectator viewing section;
means for a user to designate a desired said viewing angle from said relative location for display upon said video display; and
means to correlate said relative location with one of said individual video transmissions to said relative location and communicate a correct one of said individual video transmissions to said video display to display said desired viewing angle thereon.

2. The portable video display apparatus of claim 1 wherein said means for a user to designate a desired said viewing angle comprises:
a keyboard having a plurality of user activatable angle designation keys positioned at positions around a central point;
a said angle designation key closest to said user designating a said viewing angle from behind said user toward said playing field; and
each of said other angle designation keys designating a said viewing angle in a line from said key toward said central point.

3. The portable video display apparatus of claim 2 wherein said keys are positioned on a surface of said housing.

4. The portable video display apparatus of claim 2 wherein said angle designation keys are a displayed on one of said video display or a second video display and are touch sensitive.

5. The portable video display apparatus of claim 1 wherein said means to ascertain a relative location of said video display in said spectator viewing section is one of a GPS system or radio triangulation system.

6. The portable video display apparatus of claim 2 wherein said means to ascertain a relative location of said video display in said spectator viewing section is one of a GPS system or radio triangulation system.

7. The portable video display apparatus of claim 5 wherein said means to correlate said relative location with one of said individual video transmissions is software, said software receiving said relative location and calculating which of said video transmissions will yield said desired viewing angle chosen by said user.

8. The portable video display apparatus of claim 6 wherein said means to correlate said relative location with one of said individual video transmissions is software, said software receiving said relative location and calculating which of said video transmissions will yield said desired viewing angle chosen by said user.

9. The portable video display apparatus of claim 5 additionally comprising:
wireless means to communicate with a network at said venue;
said network communicating food items available at said venue from a plurality of different locations;
software on said display apparatus allowing said user to place an order for said food items using said keyboard; and
said order deliverable to said user using said relative location as a destination for delivering said order.

10. The portable video display apparatus of claim 6 additionally comprising:
wireless means to communicate with a network at said venue;
said network communicating food items available at said venue from a plurality of different locations;
software on said display apparatus allowing said user to place an order for said food items using said keyboard; and
said order deliverable to said user using said relative location as a destination for delivering said order.

11. A method of providing individualized video displays of the field of play at a venue having a spectator viewing section surrounding a field of play and having a plurality of cameras communicating individual video transmissions of said field of play from a plurality of different viewing angles around said field of play, comprising the steps of:
providing a user with a video display apparatus capable of receiving and displaying each of said individual video transmissions;
providing said video display apparatus with a means to ascertain its relative location in said spectator viewing section relative to said field of play;
providing means for said user to designate a desired said viewing angle, from said plurality of different viewing angles, for display upon said video display; and
providing said video display apparatus with means to correlate said relative location of said user in said spectator viewing section to a correct one of said individual video transmissions to communicate said desired viewing angle of said user to said video display.

12. The method of providing individualized video displays of claim 11 wherein said means for said user to designate a desired said viewing angle is a keyboard having a plurality of user activated angle designation keys positioned around a central point with one said angle designation key closest to said user designating a viewing angle from behind said user toward said playing field with each of said other angle designation keys designating a said viewing angle in a line from said key toward said central point.
